(19) United States
(12) Patent Application Publication
(10) Pub. No.: US 2012/0290273 A1
(43) Pub. Date: Nov. 15, 2012

(54) SYSTEM AND METHOD FOR CALCULATING GREENHOUSE GAS EMISSIONS IN THE PRODUCTION OF RAW MATERIAL FOR OBTAINING BIOPRODUCTS

(75) Inventors: Ricardo ARJONA ANTOLIN, Sevilla (ES); Maria de las Nieves Valenzuela Romero, Sevilla (ES); Jesús Lopez Lopez, Sevilla (ES); Macarena Marquez Piñuela, Sevilla (ES); Rocio Garcia Encinas, Sevilla (ES); Maria Angeles Gutierrez Montero, Sevilla (ES); Beatriz Alonso Martinez, Madrid (ES); Raquel Diaz Molist, Madrid (ES); Jesús Yañez Vidal, Sevilla (ES); Laura Montes Garcia, Sevilla (ES)

(73) Assignee: ABENGOA BIOENERGIA NUEVAS TECNOLOGIAS, S.A., Sevilla (ES)

(21) Appl. No.: 13/103,331

(22) Filed: May 9, 2011

(51) Int. Cl. G06F 17/10

(52) U.S. Cl. 703/2

(57) ABSTRACT

For quickly and remotely obtaining the GHG emissions, without providing the sites of raw material production with means for collecting parameters. The system comprises a processing unit to execute instructions related to the determination of the emissions; a database for storing the relevant parameters related to the processes for the production of raw material; a data transmission means connected to the database and the processing unit, to retrieve said parameters from the database and transmitting said parameters to the processing unit, and a GHG emissions modeling module connected to the processing unit and adapted to generate a GHG emissions level. The method comprises considering a partial calculation for the emissions related to any process and adding them up to obtain an overall value for said GHG emissions.

### OBJECT OF THE INVENTION

The invention hereby disclosed is related to the field of sustainability and environmental control in the production of raw material for obtaining bioproducts.

The objective of the invention is a system and a method for calculating the value of greenhouse gas (GHG) emissions in the production of raw material for obtaining bioproducts.

### BACKGROUND OF THE INVENTION

Bioproducts include building materials, pulp and paper, forest products, biofuels, bioenergy, starch-based and cellulose-based ethanol, bio-based adhesives, biochemicals, bioplastics, etc. Bioproducts are active subjects of research and development, and these efforts have developed significantly since the turn of the 20/21st century, mainly driven by the environmental impact of petroleum use. Bioproducts derived from bioresources can replace much of the fuels, chemicals, plastics, etc. that are currently derived from petroleum.

For example, as a sort of bioproduct, bioenergy is renewable energy made available from materials derived from biological sources and includes different forms, such as: biofuels, bioliquids, biogas, renewable electricity and renewable thermal energy. In its most narrow sense it is a synonym to biofuel, which is fuel derived from biological sources. In its broader sense it includes biomass, the biological material used as a biofuel, as well as the social, economic, scientific and technical fields associated with using biological sources for energy. This is a common misconception, as bioenergy is the energy extracted from the biomass, as the biomass is the fuel and the bioenergy is the energy contained in the fuel.

Biomass is any organic material which has stored sunlight in the form of chemical energy. As a fuel it may include wood, wood waste, straw, manure, sugarcane, and many other bioproducts from a variety of biological processes.

There is a slight tendency for the word bioproduct to be favoured in Europe compared with biofuel in North America; bioproduct means renewable energy obtained from biological materials, and includes: biofuels, bioliquids, biogas, renewable electricity and renewable thermal energy.

As an example of bioproduct, biofuels are gaining increased public and scientific attention, driven by factors such as oil price spikes, the need for increased energy security, and concern over greenhouse gas emissions from fossil fuels. Biofuels are used among others for ETBE production (gasoline additive), or for direct blending with gasoline or diesel. Being renewable energy sources, biofuels reduce CO₂ emissions, and contribute to the security and diversification of the energy supply, while reducing the dependency on fossil fuels in the transportation and helping towards compliance with the Kyoto Protocol.

In some way it seems to be clear that the use of raw material to produce a bioproduct is an alternative to the use of other fossil fuels thus producing less GHG, but it is necessary to make sure that the total emissions related to said bioproducts are not higher than the emissions related to the fossil fuels.

Most of the GHG emissions related to bioproducts can be associated to the production processes of raw material for obtaining said bioproducts. Therefore it is necessary to focus on the reduction of GHG emissions related to such processes for production of raw material.

Obtaining in the production sites of said raw material the relevant parameters for obtaining the GHG emissions related to the production of raw meterial is usually not possible due to the large amount of time and resources which have to be consumed for collecting said parameters.

Therefore, there is a necessity of quickly and remotely calculating the GHG emissions in the production of raw material, without providing the sites of production with means for collecting parameters. The GHG emissions should be known before the taking of the decision of buying said raw material.

### DESCRIPTION OF THE INVENTION

The invention relates to a system and a method for determining the GHG emissions involving the different processes and steps for the production of raw material for obtaining bioproducts. The specific purpose of this invention is to describe the obtaining of GHG emission relative to the production processes of raw material for bioproducts.

Bioproducts comprise bioenergy, as well as products like bioplastics, Furfural, APP, APG, Fumaric Acid, Acetic Acid, Lactic Acid, Xylitol, PHA,

Sorbitol, Itaconic Acid, Adipic Acid, 1,4-butanediol, 1,3-propanediol, Succinic Acid, Acrylic Acid, Resins, Carbon fiber, Phenol, or Quinones, among others.

A form of bioenergy may be biofuels, such as bioethanol or biodiesel, or may be biogas, bioliquids, renewable electricity or renewable thermal power, among others.

Next, some definitions corresponding to some terms which will be used below are provided.

Processing unit: any device (for instance, a computer) adapted to receive/retrieve data from a database or storing means (such as a readable memory), perform calculations and send the result of the calculations to output means (screen, printer, etc)

Parameter calculated: parameter that can be obtained from other.

Reference values: Values obtained from databases and literature data for the same product or process or related ones.

Activity data: a characteristic parameter of the activity or of the means used to perform each process, which allows determining the emissions for a given period through calculation.

Emission factor: a parameter that indicates the quantity of a particular GHG emitted directly or indirectly from a particular process by unit of activity data.

According to a first aspect, the invention relates to a system for calculating greenhouse gas (GHG) emissions in the production of raw material for obtaining bioproducts, comprising: at least one processing unit adapted to execute instructions related to the determination of GHG emissions in the production of raw material for obtaining bioproducts; at least one database, accessible by at least the processing unit, and adapted for storing at least one relevant parameter related to the processes for the production of raw material; data transmission means adapted to transmit data and connected to at least both the database and the processing unit, and adapted to receive from the processing unit instructions for retrieving said parameters from the database and transmitting said parameters to the processing unit; and a GHG emissions modeling module embodied as a software and connected to the processing unit and adapted to generate a GHG emissions level, wherein the at least one database is accessible at least by the processing unit by means of the data transmission means.

Preferably, the system further comprises displaying means for representing the GHG emissions.

It is preferred that the relevant parameters comprise parameters retrieved, with the mediation of retrieving means, from a storing means, said storing means storing information relating to the production of raw material for obtaining bioproducts.

Preferably, the processing unit comprises: at least one processor adapted to process at least the GHG emissions parameters; al least one memory connected to the processor; and storage means accessible by the processing unit adapted to store at least some instructions related to the process of at least the GHG emissions parameters.

The data transmission means are preferably selected from the group consisting of: wired communication means, wireless communication means and near field communication means.

The database may preferably further comprise at least a quality index relating to at least one of the relevant parameters. The quality index indicates the reliability of the parameter to which it refers. The lower the quality index is, the higher the reliability for the parameter is.

The database is preferably allocated at a server accessible by the GHG emissions modeling module and/or the processing unit. As an alternative, the database is allocated at the storage means.

According to a second aspect, the invention relates to a method for calculating greenhouse gas (GHG) emissions related to the production of raw material intended to be transformed in bioproducts, the production of raw material comprising: processes for extraction and cultivation of raw material; processes for collection of raw material; processes for treatment of raw material waste and leakages; and processes for production of chemicals or products used in extraction and cultivation of raw material, wherein the method comprises the steps of:

a) retrieving, from a database by means of the GHG emissions modeling module, using instructions received from the processing unit, relevant parameters related to processes for extraction and cultivation or raw material;

b) retrieving, from a database by means of the GHG emissions modeling module, using instructions received from the processing unit,relevant parameters related to processes for collection of raw material;

c) retrieving, from a database by means of the GHG emissions modeling module, using instructions received from the processing unit, relevant parameters related to processes for treatment of raw material waste and leakages;

d) retrieving, from a database by means of the GHG emissions modeling module, using instructions received from the processing unit, relevant parameters related to processes for production of chemicals or products used in extraction and cultivation of raw material;

e) providing a processing unit with said parameters, said control unit having instructions for calculating the GHG emissions;

f) processing the parameters related to each process involved in the raw material production for calculating a partial GHG emissions value related to each process, and

g) adding up said partial values for calculating an overall GHG emissions value.

Preferably, the processing step f) comprises multiplying an activity data by an emission factor, being the activity data a characteristic parameter of the activity or of the means used to perform each process, which allows determining the emissions for a given period through calculation, and being the emission factor a parameter that indicates the quantity of a particular GHG emitted from a particular process by unit of activity data. Preferably the activity data for a process could be composed by a combination of several parameters and constant factors.

It is preferred that the raw material extraction and cultivation processes comprise at least one process selected from: soil tillage; seed fabrication, sowing; irrigation; fertilizer application; pesticides application; NO₂ direct and indirect emissions from soil and organic amendments. The recovering step a) may comprise at least one action selected from:
retrieving, from a database by means of the GHG emissions modeling module, using instructions received from the processing unit, relevant parameters for the energy consumption during tillage operation;
retrieving, from a database by means of the GHG emissions modeling module, using instructions received from the processing unit, relevant parameters related to quantity of seed fabrication;
retrieving, from a database by means of the GHG emissions modeling module, using instructions received from the processing unit, relevant parameters for the energy consumption of a sowing machine;
retrieving, from a database by means of the GHG emissions modeling module, using instructions received from the processing unit, relevant parameters for the energy consumed in pumping irrigation water;
retrieving, from a database by means of the GHG emissions modeling module, using instructions received from the processing unit, relevant parameters for the energy consumption in the fertilizer application;
retrieving, from a database by means of the GHG emissions modeling module, using instructions received from the processing unit, relevant parameters for the energy consumption for applying pesticides;
retrieving, from a database by means of the GHG emissions modeling module, using instructions received from the processing unit, parameters relevant for the N₂O direct and indirect emissions: these emissions are associated to nitrous oxide emissions from soil due to direct nitrogen emissions, as well as leaching and volatilization of nitrogen;
retrieving, from a database by means of the GHG emissions modeling module, using instructions received from the processing unit, parameters relevant for the emissions related to organic amendments application: these emissions are associated to substitution of nitrogen-based inorganic fertilizer

Preferably, the processes for collection of raw material comprise at least one process selected from: harvesting of raw material; transport of raw material inside the parcel; transport of raw material to the raw material storing site; storage of raw material; and driying of raw material. The recovering step b) may comprise at least one action selected from:
retrieving, from a database by means of the GHG emissions modeling module, using instructions received from the processing unit, relevant parameters for the energy consumption of a harvesting machine;
retrieving, from a database by means of the GHG emissions modeling module, using instructions received from the processing unit, relevant parameters for the energy consumption of a transport means for transporting the raw material inside the parcel;
retrieving, from a database by means of the GHG emissions modeling module, using instructions received from the processing unit, relevant parameters for the energy consumption of a transport means for transporting the raw material from the parcel to the harvested raw material storage site;
retrieving, from a database by means of the GHG emissions modeling module, using instructions received from the processing unit, relevant parameters for the energy consumption related to the load and unload of the raw material inside de storage site and the maintenance of controlled conditions in said storage site;
retrieving, from a database by means of the GHG emissions modeling module, using instructions received from the processing unit, relevant parameters for the energy and/or energy consumption in raw material drying operations.

It is preferred that the processes for treatment of raw material waste and leakages comprise at least one process selected from: raking; baling, bale collecting and bale transporting. The recovering step c) may comprise at least one action selected from:
retrieving, from a database by means of the GHG emissions modeling module, using instructions received from the processing unit, relevant parameters for the energy consumption of a raking machine;
retrieving, from a database by means of the GHG emissions modeling module, using instructions received from the processing unit, relevant parameters for the energy consumption of a baling machine;
retrieving, from a database by means of the GHG emissions modeling module, using instructions received from the processing unit, relevant parameters for the energy consumption of a machine for collecting bales; and
retrieving, from a database by means of the GHG emissions modeling module, using instructions received from the processing unit, relevant parameters for the energy consumption of a machine for transporting said bales to a bale storage site.

Preferably, the processes for production of chemicals or products used in extraction and cultivation of raw material comprise at least one process selected from: fabrication of fertilizers and fabrication of pesticides. The recovering step d) may comprise at least one action selected from:
retrieving, from a database by means of the GHG emissions modeling module, using instructions received from the processing unit, relevant parameters related to the composition and quantity of fertilizer used; and
retrieving, from a database by means of the GHG emissions modeling module, using instructions received from the processing unit, relevant parameters related to the composition and quantity of pesticide used.

The partial GHG emissions factor related to the fertilizer fabrication may be preferably calculated as a weighted average of the emission factor of each type of fertilizer according to the quantity used in each geographical area.

The quantity of fertilizer used (i.e. the corresponding activity factor) may be estimated following from parameters relating to the overall production of raw material; the overall consumption of fertilizer; the theoretical fertilization ratio; and the overall surface involved in the production of raw material, according to the next steps:
retrieving from the database, by means of the GHG emissions modeling module, using instructions received from the processing unit, a parameter related to the overall production of raw material;
retrieving from the database, by means of the GHG emissions modeling module, using instructions received from the processing unit, a parameter related to the overall consumption of fertilizer;
retrieving from the database, by means of the GHG emissions modeling module, using instructions received from the processing unit, a parameter related to the theoretical fertilization ratio indicating the quantity of raw material produced per area unit;
retrieving from the database, by means of the GHG emissions modeling module, using instructions received from the processing unit, a parameter related to the overall surface involved in the production of raw material,
transmitting, using the data transmission means, the parameters calculated in the previous steps to the processing unit, and
calculating, using the GHG emissions modeling module, the quantity of fertilizer used, by adjusting the real fertilizer consumption with the theoretical fertilization ratio.

The relevant parameters preferably comprise parameters related to the type of the raw material and the location of the production of the raw material.

The type of raw material may be selected from any sort of organic material which may be transformed in any kind of bioproducts. Preferably raw material is selected from at least one from: cereals, sugar cane, straw, forestry material (such as trees), forestry residues, organic waste, wine alcohol, aquaculture and fishery residues and oleaginous crops, as well as energy crops, among others.

According to a preferred embodiment, the relevant parameters stored in the database may be accompanied with a quality index relating said parameters, following preset criteria. The lower the quality index is, the higher the reliability for parameter value is. The method of the invention is intended to be subject to a continuous improvement process, one aspect of which is storing in the database updated parameters with the highest reliability available. Therefore, before storing an updated parameter, a comparison should be done between the index quality relating the updated parameter and the quality index relating the current parameter, so that the updated parameter substitutes the stored parameter if the quality index relating said updated parameter is lower than the one relating the current parameter according to the preset criteria.

At least one of relevant parameters is preferably associated to a quality index before storing said parameter in the database, together with said quality index.

Said quality index may be used for establishing an improvement of the method. The method is improved by substituting the values of the parameters currently recorded in the database by values of more recently determined (updated) parameters relating the same processes, provided that the quality index of the more recently determined parameters is lower than the quality index of the parameters currently recorded in the database. According to the object of the improvement, the method can further comprise the steps of
retrieving, from a database by means of the GHG emissions modeling module, using instructions received from the processing unit, the quality index of a parameter currently stored in the database;
comparing the quality index of said parameter stored in the database with the quality index of a parameter more recently calculated for determining whether the quality index of the parameter currently stored is lower than the quality index of the more recently calculated parameter;
substituting the currently stored parameter by the more recently calculated parameter if the comparison determines that the quality index of the parameter currently stored is higher than the quality index of the more recently calculated parameter.

The method may also be employed for assessing whether a determined origin or raw material is sustainable, i.e. that the overall GHG emission relating said raw material or origin are lower than preset threshold values.

According to this, the method can further comprise the steps of:
retrieving, from a database by means of the GHG emissions modeling module, using instructions received from the processing unit, a maximum GHG emissions threshold for a determined raw material;
calculating the overall GHG emission values for said determined raw material relating a plurality of production sites for said raw material;
comparing said overall GHG emission values to said GHG emissions threshold; and
determining that a raw material production site is sustainable for the determined raw material if the GHG emissions of said raw material relating to said raw material production site are lower than the theshold.

or
retrieving, from a database by means of the GHG emissions modeling module, using instructions received from the processing unit, a maximum GHG emissions threshold for a determined raw material production site;
calculating the overall GHG emission values for said determined raw material production site relating a plurality of raw material for said production site;
comparing said overall GHG emission values to said GHG emissions threshold; and
determining that a raw material is sustainable for the determined raw material production site if the GHG emissions of said raw material production site relating to said raw material are lower than the threshold.

The method preferably shows the result of the GHG emissions determined. The method may also output whether the raw material or the origin are sustainable according to what has been stated above. The output may be performed through various media, preferably through a table or a map.

The system and the method of the invention allow the determination of the value of greenhouse gas (GHG) emissions in the production of raw material for obtaining bioproducts, without needing to provide the production sites for raw material without means for collecting the relevant parameters. After all relevant parameters are stored in the database, the system of the invention can calculate the overall GHG emissions for a determined raw material relating to a determined raw material production site. Knowing the value of the emissions will help to decide which raw materials produced in which production sites comply with sustainability requirements, and thus, affect the purchasing orders. For example, the method allows taking decision of purchasing a raw material produced in a raw material production site wherein the overall GHG emission level related to the production of said raw material in said raw material production site is lower than a determined threshold value.

Another object of the invention is a computer readable storage medium storing processor executable instructions for performing a method for determining greenhouse gas (GHG) emissions in the production of raw material for obtaining bioproducts, the production of raw material comprising: processes for cultivation or extraction of raw material; processes for collection of raw material; processes for treatment of raw material waste and leakages; and processes for production of chemicals or products used in extraction and cultivation of raw material, the method comprising the steps of:

a) retrieving, from a database by means of the GHG emissions modeling module, using instructions received from the processing unit, relevant parameters related to processes for extraction and cultivation or raw material;

b) retrieving, from a database by means of the GHG emissions modeling module, using instructions received from the processing unit, relevant parameters related to processes for collection of raw material;

c) retrieving, from a database by means of the GHG emissions modeling module, using instructions received from the processing unit, relevant parameters related to processes for treatment of raw material waste and leakages;

d) retrieving, from a database by means of the GHG emissions modeling module, using instructions received from the processing unit, relevant parameters related to processes for production of chemicals or products used in extraction and cultivation of raw material;

e) providing the processing unit, using the data transmission means, with said relevant parameters, said processing unit having instructions for calculating the GHG emissions by means of the GHG emissions modeling module to which is connected;

f) processing in the processing unit the relevant parameters related to each process involved in the raw material production for calculating a partial GHG emissions value related to each process, and

g) adding up said partial values for calculating an overall GHG emissions level.

Another object of the invention is a computer readable storage medium storing processor executable instructions for performing a method for determining greenhouse gas (GHG) emissions in the production of raw material for obtaining bioproducts, the production of raw material comprising: processes for cultivation or extraction of raw material; processes for collection of raw material; processes for treatment of raw material waste and leakages; and processes for production of chemicals or products used in extraction and cultivation of raw material, wherein the method comprises the steps of:

a) retrieving, from a database by means of the GHG emissions modeling module, using instructions received from the processing unit, relevant parameters related to processes for extraction and cultivation or raw material;

b) retrieving, from a database by means of the GHG emissions modeling module, using instructions received from the processing unit, relevant parameters related to processes for collection of raw material;

c) retrieving, from a database by means of the GHG emissions modeling module, using instructions received from the processing unit, relevant parameters related to processes for treatment of raw material waste and leakages;

d) retrieving, from a database by means of the GHG emissions modeling module, using instructions received from the processing unit, relevant parameters related to processes for production of chemicals or products used in extraction and cultivation of raw material;

e) providing the processing unit, using the data transmission means, with said relevant parameters, said processing unit having instructions for calculating the GHG emissions by means of the GHG emissions modeling module to which is connected;

f) processing in the processing unit the relevant parameters related to each process involved in the raw material production for calculating a partial GHG emissions value related to each process, and

g) adding up said partial values for calculating an overall GHG emissions level, and

h) purchasing a raw material produced in a raw material production site wherein the overall GHG emission level related to the production of said raw material in said raw material production site is lower than a determined threshold value.

### BRIEF DESCRIPTION OF THE DRAWINGS

FIGS. 1 and 2 show the calculations for the GHG emissions in some of the stages that comprise the raw material production.

### DESCRIPTION OF A PREFERRED EMBODIMENT

A first object of the invention is a system for determining the GHG (greenhouse gas) emissions involved in the production of raw materials intended to be transformed in bioenergy. A preferred embodiment is described below on a basis of raw material intended to be transformed in biofuel as a particular form of bioenergy. A second object is a method for determining said GHG emissions.

The biofuel may further comprise a co-product of biofuel. Additionally, the biofuel may be, among others, bioethanol or biodiesel.

The raw materials intended to be transformed in biofuel can be of various types, for example: barley, wheat, corn, sorghum, sugar cane, straw, forestry residues, organic waste, wine alcohol, aquaculture and fishery residues, oleaginous crops, among others. The production of raw material can be located in various places all over the world.

The raw material production involves a number of processes. These processes may be classified in the next groups:
processes for extraction and cultivation of raw material;
processes for collection of raw material;
processes for treatment of raw material waste and leakages; and
processes for production of chemicals or products used in the extraction or production of raw material.

Each of the groups of processes identified above comprises a plurality of other processes. For example:
processes for extraction and cultivation of raw material comprise: soil tillage, seed fabrication, sowing, irrigation, fertilization application, pesticides application, N₂O direct and indirect emission from soil and organic amendment application;
processes for collection and storage of raw material comprise: harvesting, transport of harvested biomass inside the parcel of production, transport of harvested biomass to a initial storage site, storage of the harvested biomass, and drying of the harvested biomass.
processes for treatment of raw material waste and leakages comprise: raking, baling, bale collection, and bale transporting; and transporting bales to storage.
processes for production of chemicals or products used in the extraction or production of raw material comprise: fabrication of fertilizers, organic amendments and pesticides.

i) Emissions from the extraction and cultivation process.
Tillage (energy consumption). The emissions due to tillage are directly due to the energy consumption. Within this method, an average ratio for each geographical area is established. The emissions are calculated with an estimation of the machine energy consumption during operation and multiplying by the corresponding emission factor.
Seed fabrication. The emissions related to the seed fabrication are directly due to the quantity of seed consumed in the seeding process, multiplied by the seed fabrication emission factor.
Sowing. The emissions are calculated with an estimation of the machinery energy consumption during the operation and multiplying by the corresponding emission factor.
Irrigation. The method estimates the electricity consumed for the water pumping at the pressure needed and multiplying by the emission factor depending of the electricity mix of each geographical area.
Fertilizer application. The emissions are calculated with an estimation of the machinery energy consumption during the operation and multiplying for the corresponding emission factor. It is not possible to have a direct relationship between the production yield and the fertilizer application. In connection with the emission factor, because of the absence of information about the real quantity of raw material used, it has been established an average emission factor in the pesticide fabrication.
Pesticides application. The emissions are calculated with an estimation of the machinery energy consumption during each operation and multiplying by the corresponding emission factor.
N₂O direct and indirect emissions: these emissions are associated to nitrous oxide emissions from soil due to direct nitrogen emissions, as well as leaching and volatilization of nitrogen, multiplied by the corresponding emission factor.
Organic amendments application: The emissions are calculated through an estimation of the machinery energy consumption during each operation and multiplying by the corresponding emission factor. Additionally, these emissions are associated to substitution of nitrogen-based inorganic fertilizer. This calculation affects on N₂O emissions and N fertilizer fabrication.

ii) Emissions from the collection of raw materials.
Harvesting. The emissions are calculated with an estimation of the harvester energy consumption during the operation and multiplying by the corresponding emission factor.
Raw material field transport. The method considers the transportation of the raw material within the parcel. The emissions are calculated with an estimation of the harvester energy consumption during the operation and multiplying by the corresponding emission factor.
Transport of raw material to storage. The method considers the emission associated to the transport of raw material from the parcel to the initial storage where it is compiled. The emissions are calculated with an estimation of the energy consumption during the transportation of raw material and multiplying by the corresponding emission factor.
Storage operation. The method considers the consumption due to daily operation in the storage (electricity consumption, gas, etc). The method considers multiplying the corresponding emission factor by an estimation of the energetic consumption due to the loading and unloading of the raw material and the internal movements of said raw material for the aeration and maintenance in controlled conditions.
Drying of raw material. It has been considered that diesel; natural gas and electricity can be used for drying of raw material, so it is possible to select each type of energy. The method considers multiplying the energy consumption during the drying process by the corresponding emission factor.

iii) Emissions from waste and leakages:
Raking. The method considers a swept of the straw spread out on the soil. The GHG emissions are related to the energy consumption during operation, multiplying by the corresponding emission factor.
Baling. The method considers the straw collection and baling forming bales that are placed on the soil. The GHG emissions are related to the energy consumption during operation, multiplying by the corresponding emission factor.
Collecting bales. The method considers the collection of the straw bales and preparation to be transported to the storage. The GHG emissions are related to the energy consumption during operation, multiplying by the corresponding emission factor.
Transport bales to storage. The method considers the transportation from the parcel to the first storage. The GHG emissions are related to the energy consumption during operation, multiplying by the corresponding emission factor.

iv) Emissions from the production of chemicals or products used in extraction and cultivation.
Fabrication of fertilizers N, P and K. The method is based on an activity fertilizer consumed, from statistics, or other sources, and an emission factor. The emissions factor for the fertilizer fabrication is calculated as a weighted average of the emission factor of each type of fertilizer according to the quantity used in each zone.
Pesticides fabrication. The method is based on an activity data of pesticides consumed from statistics, or other sources and an emission factor.

As stated above, each of the processes identified above (for example, sowing or raw material storing) require the use of machinery and/or products/chemicals, as well the consumption of energy and/or fuel.

Each of said processes is defined by parameters which are stored in a database where they are stored at the disposal of a user. For example, a parameter would be the energy consumption of a sowing truck or the energy consumption (electricity or gas, for instance) for maintaining suitable temperature and humidity in a storing site.

A processing unit is arranged to process the parameters for calculating the GHG emissions. A transmitting means is connected to both the processing unit and the database and performs the tasks of recovering the parameters from the database and transmitting said parameters to the processing unit.

The processing unit calculates the GHG emission assigned to a quantity of produced raw material in a level by level sequence as will be explained below: As stated above, the raw material production is divided in groups of processes, each involving some processes which may on tour be subdivided defining as many levels as necessary to cover all necessary actions related to the raw material production. The processing unit is arranged to calculate the GHG emissions of every action or component in the lowermost level according to the next formula:

PartialGHGEmissionValue=ActivityData·EmissionsFactor

and then to add them up to determine a partial result for the GHG emissions relating to that level, and then consecutively sum the emissions corresponding to all the levels until the overall GHG emission values corresponding to the entire production of raw material are finally obtained.

For example, calculating the GHG emissions related to producing the fertilizers involve adding up the calculation of the partial GHG emissions related to the production of any component of the fertilizer (Nitrogen, Phosphorus, etc). In a similar way the emissions related to the production of pesticides are calculated. Both fertilizers and pesticides emissions are added up to determine the emissions related to the processes for production of chemicals or products used in the extraction or production of raw material and then added up with partial emissions determined analogously for the processes for extraction and cultivation of raw material, the processes for collection of raw material and the processes for treatment of raw material waste and leakages, to obtain an overall value for said GHG emissions.

According to what is stated above, the GHG emissions relating the entire production process of raw material is calculated according to the following formula, where “i” relates to each of the total of “n” process, sub process, operation, etc.

$${Emissions}_{Operation\_i} = {\sum }_{i = 1}^{n} ( {ActivityData}_{i} \cdot {EmissionsFactor}_{i} )$$

wherein:
n is the number of operations in a stage, in which:
Activity data: is a characteristic parameter of the activity or of the equipment, installations, processes or vehicles associated with a given source, which allows determining their emissions for a given period through calculation. Examples of activity data are the energy consumption, the consumption of raw material, the distance covered by vehicles, etc. The value of each activity data could vary due to different raw material types, geographical area or also with the cultivation conditions. The resulting activity data for a defined sub operation could be composed by a combination of several parameters and constant factors.

Emission Factor: is a parameter that indicates the quantity of a particular GHG emitted from a particular activity by unit of product, volume, duration, quantity of raw material or energy etc, and that is by unit of what has been designated as “activity data”. The value of each emission factor could vary due to different raw material types, geographical area or also with the cultivation operations.

It is worth mentioning that both the activity data and the emission factor may be calculated from the same parameter/s, or it is also feasible to calculate the activity data value from one or more parameters and the emission factor from one or more parameters different to those used to calculate the activity data; furthermore when using more than one parameter to calculate either the emission factor or the activity data, it might happen than one of those parameters is used to calculated both the activity data and the emission factor.

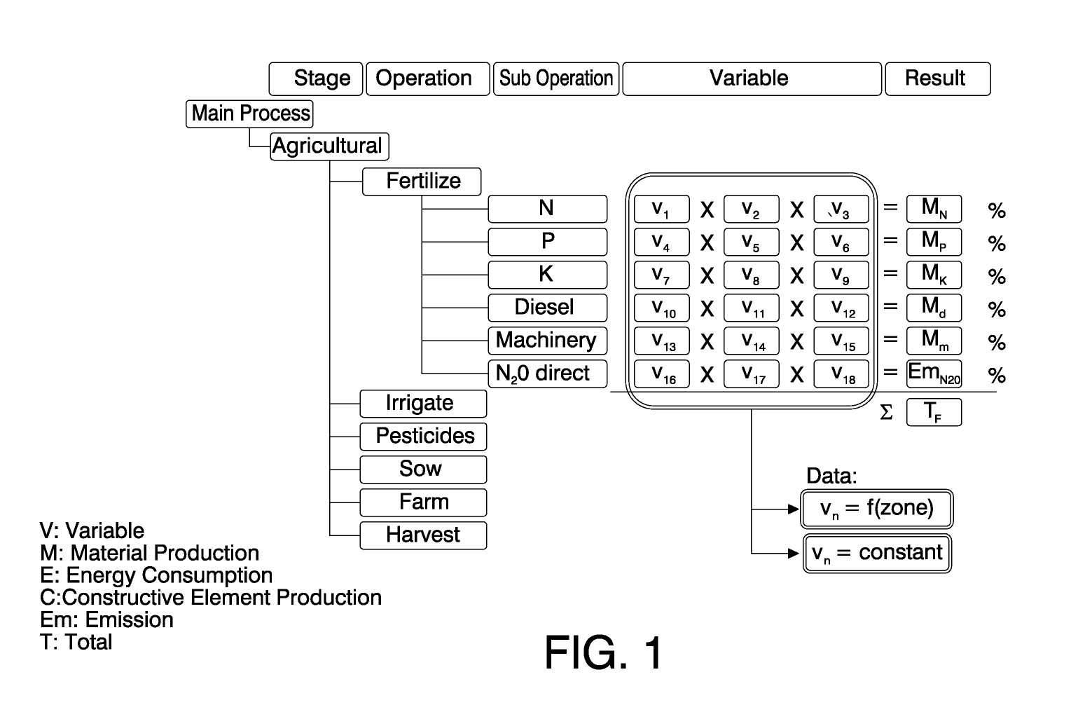

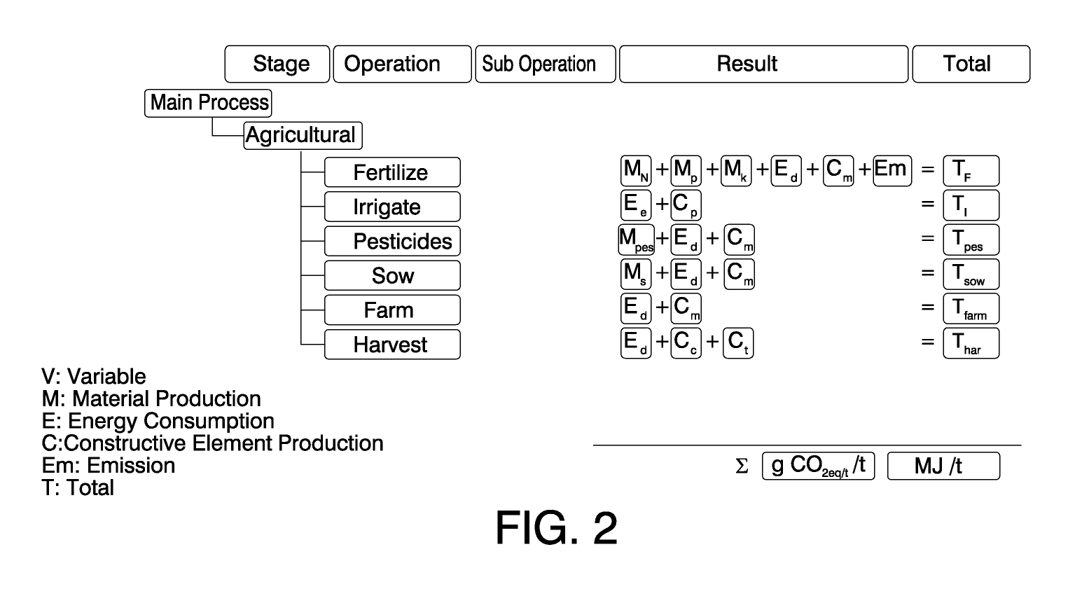

The sequential calculation per process or sub operation is the same:
1) Selection of the corresponding suboperation per each operation depending of the raw material production site and raw material type.
2) Selection of the parameters needed in each suboperation to be incorporated within the calculation formula. These parameters (V, in the FIGS. 1 and 2) cover both emissions factor and activity data.
3) Calculation performance using the corresponding formula and parameters for each suboperation.
   Results for each subtask and the final result of the stage analyzed adding the individual result of each task integrated for its corresponding sub tasks.

FIGS. 1 and 2 show the calculations for the GHG emissions in some of the stages that comprise the raw material production.

The value for GHG emissions will be related to a CO₂ equivalent value. For the purpose of calculating said CO₂ equivalent value, the gases to be valued are at least one from: CO₂; N₂O; CH₄; HFC's, PFC's and SF₆.

The parameters can show or not show a dependency on the type of raw material, as well as said parameters may on tour show or not show a dependency on the geographical level. Said dependency on the geographical level means that the parameters show different values if they are determined considering corresponding processes related to different areas, for example, some parameters for sowing may depend or not depend of whether the sowing takes place in France or in the USA.

The parameters may be determined from the processes for raw material production or may be determined by taking said parameters from collected data such as data bases and/or literature data with/without dependency on cultivation. Irrespective of whether there is o there is not a dependency of the geographical level, the parameters collected from data bases and/or literature data may have different geographical scope (country, continental o global scope). It means that the data may be collected from data bases or literature relating to a NUTS 3, to NUTS 2 o to country. The quality index related to the geographical scope of the literature or data basis is higher the narrower the geographical scope is.

As stated above, the parameter values stored in the database are accompanied by a quality index, giving information about the reliability of said parameter value, which may have several components. One of said components is related to the geographical scope of the literature or data basis in which said parameter value has been found. The value for said component is higher the narrower the geographical scope is. In this case, as NUTS 3 relates to a narrower geographical scope than NUTS 2 or country, a value for a parameter which is found in a NUTS 3 geographical scope has lower component for the quality index relating to geographical scope, and hence, higher reliability.

There is also a component of the quality index related to the type of the source (database or literature) from which the data are collected. According to it, the data may come from (decreasing quality level, therefore increasing the component of quality index) statistical data from official bodies, statistical data from prestigious sources or published technical/scientific reports. If no data are found following these types of source for the geographical area in which the raw material production for which the data are being searched is occurring, then data from another geographical area or raw material with agronomical conditions similar must be considered, which will have a higher component for the quality index (lower reliability).

There is also a component for the quality index which is related to the relevant date for which the data are selected. If the data come from the current year, the component for the quality index is lower (higher reliability) than that related to data selected from a previous year.

As will be explained below, the quality index for any parameter value has three components: (a, b, c) in case of dependency of geographical level, or (b, a, c) in case of not dependency of geographical level (i.e. the value for the parameter depends or not on the cultivation origin of the raw material to which the parameter relates). Component “a” refers to the geographical level of the database or literature in which the value for the parameter is found. Component “b” refers to the type of source in which the value is found. Component “c” refers to the date for which the value is found.

For several quality indexes relating to the same parameter, the quality level (and hence the reliability) is higher the lower the first component (“a”, in case of dependency, “b” in case of no dependency on the geographical level) is. For several quality indexes relating to the same parameter, which have the same value for the first component, the quality level is higher the lower the second component is. Accordingly, for several quality indexes relating to the same parameter, which have the same value for the first and the second components, the quality level is higher the lower the third component is.

According a quality index for any parameter value is useful for improving the reliability of the GHG emission value obtained, since it allows substituting a current value for a determined parameter stored in the database by a new value only if, after comparing the quality indexes for both values, the quality index associated to the new value shows higher reliability than that associated to the current value.

Next, the determination of the quality index for the parameters determined by taking them from literature or databases is explained, wherein the parameters do not show dependence on the cultivation, i.e. the type of raw material considered.

First, a parameter identification has to be performed. It means that the first task aims to identify the parameters that shall be used. The parameters may be Activity Data or Emission Factors.

Next, it is necessary to identify whether the parameter depends on the geographical level. (For example, emission factor for electricity depends on the mix of technologies used to produce it, so it has dependency on the geographical level, whilst truck energy consumption is considered no to have dependency on the geographical level). Next, option 1 relates to dependency and option 2 relates to not dependency on the geographical level.

Option 1: Dependency on the geographical level.

As stated above, the component relating to the geographical level is referred as “a”. When there is a dependency on the geographical level, the most important criterion when assessing the quality index is the geographical scope of the data base or the literature from which the parameter is collected. It means that, when there is dependency on the geographical level, “a” is the first component of the quality index. Three geographical levels are considered: NUTS 3, NUTS 2 or country. The component “a” has value 1 for a parameter value found in a NUTS 3 database, value 2 for NUTS 2 and value 3 for country.

As stated above, the component relating to the source type is referred as “b”. When there is a dependency on the geographical level, the second most important criterion when assessing the quality index, (after the geographical level) is the source type. It means that, when there is dependency on the geographical level, “b” is the second component of the quality index. Four source types are considered: Statistical data from official bodies, statistical data from prestigious sources, published technical/scientific reports, and data from other regions. The component “b” has value 1 for a parameter value found in a statistical data from official bodies, value 2 for statistical data from prestigious sources, value 3 for published technical/scientific reports, and value 4 for data taken from other regions.

As stated above, the component relating to the date is referred as “c”. Irrespective whether there is or not dependency on the geographical level, the third most important criterion when assessing the quality index, (after the geographical level and the source type, or vice versa) is the source type. It means that “c” is the third component of the quality index. Four date types are considered: harvest year, harvest year approach, multi-year average and last available year. The component “b” has value 1 for a parameter value found for the harvest year, value 2 for harvest year approach, value 3 for multi-year average, and value 4 for last available year.

The value for any parameter is found following an iterative search. It is searched first through a combination related to the highest level of quality, i.e. quality index=(1, 1, 1). It means, a search is performed for NUTS 3 (a=1), statistical data from official bodies (b=1) and harvest year (c=1). If no value is found for said parameter having a quality index=(1, 1, 1), then the search is performed aiming to find the value relating to the next best quality index (1, 1, 2), according to what has been explained above. The iterative search goes on, on a basis of reducing the quality index, until a value for said parameter is found. The quality index associated to the successful search is accorded to said parameter value.

The series of quality indexes is (1, 1, 1); (1, 1, 2); (1, 1, 3); (1, 1, 4); (1, 2, 1); (1, 2, 2); (1, 2, 3); (1, 2, 4); (1, 3, 1); (1, 3, 2); (1, 3, 3); (1, 3, 4); (2, 1, 1); (2, 1, 2); (2, 1, 3); (2, 1, 4); (2, 2, 1); (2, 2, 2); (2, 2, 3); (2, 2, 4); (2, 3, 1); (2, 3, 2); (2, 3, 3); (2, 3, 4); (3, 1, 1); (3, 1, 2); (3, 1, 3); (3, 1, 4); (3, 2, 1); (3, 2, 2); (3, 2, 3); (3, 2, 4); (3, 3, 1); (3, 3, 2); (3, 3, 3); and (3, 3, 4).

In this way, the value found for a parameter has always the best quality index possible with regard to the available data.

Option 2: When the parameter does not have a meaningful dependency on geographical level, the most important criterion to assess the quality index is the type of source, the second most important criterion is the geographical level and the third most important criterion is the date. It means that an iterative search is performed, similar to the one explained for option 1, only differing in that the components of the quality index are (b, a, c) instead of (a, b, c).

Next, the determination of the quality index for the parameters determined by taking them from literature or databases is explained, wherein the parameters show dependence on the cultivation.

Similarly as in the case of no dependency of cultivation explained above, first of all, the relevant type of parameter has to be identified.

Then, an iterative search similar to the one explained above relating the cases of no dependency of cultivation (option 1 and option 2) has to be performed. The order, in this case is, for the quality index is (a, b, c).

If, after having tried to perform an search corresponding to the less reliable quality index (3, 3, 4), i.e. country level, published reports and last available year, no value is found, it is necessary to perform an additional secondary iterative search, as will be explained below:

In the case of the secondary search, the order for the quality index is (b, a, c). Additionally, the source types (component “b”) are (in this order): methodological hypotheses, assign data from other geographical levels, and assign data from other raw materials, instead of statistical data from official bodies, statistical data from prestigious sources and published reports, respectively, as explained above.

Methodological hypothesis, which is related to a value of 1 for the component “b”, involves following documented and justified assumptions for estimating the value of the parameter considering the same raw material and the same geographical level of the parameter involved. Assign data from other geographical level is related to the value of 2 for the component “c”. (For example, if a parameter for corn in Spain is searched and there are no valid hypotheses for corn in Spain, the search is performed for corn in France.)

Assign data from other raw material is related to a value of 3 for the component “c”. (For example, wheat in Spain).

1. A system for calculating greenhouse gas (GHG) emissions in the production of raw material for obtaining bioproducts, comprising:
at least one processing unit adapted to execute instructions related to the determination of GHG emissions in the production of raw material for obtaining bioproducts,
at least one database accessible by at least the processing unit and comprising at least one relevant parameter related to the processes for the production of raw material;
data transmission means adapted to transmit data and at least connected to the database and the processing unit; and
a GHG emissions modeling module embodied as a software and connected to the processing unit and adapted to generate a GHG emissions level,
wherein the at least one database is accessible by at least the processing unit by means of the data transmission means.

2. The system of claim 1, further comprising displaying means for representing the GHG emissions.

3. The system of claim 1, wherein the at least one processing unit comprises:
at least one processor adapted to process at least the GHG (greenhouse gas) emissions data,
at least one memory connected to the at least one processor, and
storage means adapted to store at least the instructions executed by the at least one processor.

4. The system of claim 1, wherein the data transmission means is selected from the group consisting of: wired communication means, wireless communication means and near field communication means.

5. The system of claim 1, wherein the bioproducts comprise a bioplastic.

6. The system of claim 1, wherein the bioproducts comprise a form of bioenergy.

7. The system of claim 6, wherein the form of bioenergy is biofuel.

8. The system of claim 6, wherein the form of bioenergy is biogas.

9. The system of claim 7 wherein the biofuel further comprises a co-product of biofuel.

10. The system according to claim 9 wherein the biofuel is bioethanol.

11. The system according to claim 9 wherein the biofuel is biodiesel.

12. The system of claim 1, wherein the raw material is selected from a group comprising cereals, sugar cane, straw, forestry residues, forestry material, organic waste, wine alcohol, energy crops, aquaculture and fishery residues and oleaginous crops.

13. A method for determining greenhouse gas (GHG) emissions in the production of raw material for obtaining bioproducts, the production of raw material comprising: processes for cultivation or extraction of raw material; processes for collection of raw material; processes for treatment of raw material waste and leakages; and processes for production of chemicals or products used in extraction and cultivation of raw material, characterized in that the method comprises the steps of:
a) retrieving, from a database by means of the GHG emissions modeling module, using instructions received from the processing unit, relevant parameters related to processes for extraction and cultivation or raw material;
b) retrieving, from a database by means of the GHG emissions modeling module, using instructions received from the processing unit, relevant parameters related to processes for collection of raw material;
c) retrieving, from a database by means of the GHG emissions modeling module, using instructions received from the processing unit, relevant parameters related to processes for treatment of raw material waste and leakages;
d) retrieving, from a database by means of the GHG emissions modeling module, using instructions received from the processing unit, relevant parameters related to processes for production of chemicals or products used in extraction and cultivation of raw material;
e) providing the processing unit, using the data transmission means, with said relevant parameters, said processing unit having instructions for calculating the GHG emissions by means of the GHG emissions modeling module to which is connected;
f) processing in the processing unit the relevant parameters related to each process involved in the raw material production for calculating a partial GHG emissions value related to each process, and
g) adding up said partial values for calculating an overall GHG emissions level.

14. The method of claim 13, further comprising the step of associating a quality index to at least one parameter before storing said parameter, together with said quality index in the database.

15. The method of claim 14, further comprising the steps of:
retrieving, from a database by means of the GHG emissions modeling module, using instructions received from the processing unit, the quality index of a parameter stored in the database;
comparing the quality index of a parameter stored in the database with the quality index of a parameter more recently calculated for determining whether the quality index of the parameter stored is lower than the quality index of the more recently calculated parameter;
substituting the stored parameter by the more recently calculated parameter if the comparison determines that the quality index of the parameter stored is lower than the quality index of the more recently calculated parameter.

16. The method of claim 15 further comprising the steps of:
retrieving, from a database by means of the GHG emissions modeling module, using instructions received from the processing unit, a maximum GHG emissions threshold for a determined raw material;
calculating the overall GHG emission values for said determined raw material relating a plurality of production sites for said raw material;
comparing said overall GHG emission values to said GHG emissions threshold; and
determining that a raw material production site is sustainable for the determined raw material if the GHG emissions of said raw material relating to said raw material production site are lower than the theshold.

17. The method of claim 15 further comprising the steps of:
retrieving, from a database by means of the GHG emissions modeling module, using instructions received from the processing unit, a maximum GHG emissions threshold for a determined raw material production site;
calculating the overall GHG emission values for said determined raw material production site relating a plurality of raw material for said production site;
comparing said overall GHG emission values to said GHG emissions threshold; and
determining that a raw material is sustainable for the determined raw material production site if the GHG emissions of said raw material production site relating to said raw material are lower than the threshold.

18. The method of claim 13 further comprising the step of outputting the result of the GHG emissions determined.

19. The method of claim 16 further comprising the step of outputting whether the raw material is sustainable.

20. The method of claim 17 further comprising the step of outputting whether the origin is sustainable.

21. The method of any of claim 19 or 20 wherein the outputting is achieved through a table.

22. The method of any of claim 19 or 20 wherein the outputting is achieved through a map.

23. A method for determining greenhouse gas (GHG) emissions in the production of raw material for obtaining bioproducts, the production of raw material comprising: processes for cultivation or extraction of raw material; processes for collection of raw material; processes for treatment of raw material waste and leakages; and processes for production of chemicals or products used in extraction and cultivation of raw material, characterized in that the method comprises the steps of:
a) retrieving, from a database by means of the GHG emissions modeling module, using instructions received from the processing unit, relevant parameters related to processes for extraction and cultivation or raw material;
b) retrieving, from a database by means of the GHG emissions modeling module, using instructions received from the processing unit, relevant parameters related to processes for collection of raw material;
c) retrieving, from a database by means of the GHG emissions modeling module, using instructions received from the processing unit, relevant parameters related to processes for treatment of raw material waste and leakages;
d) retrieving, from a database by means of the GHG emissions modeling module, using instructions received from the processing unit, relevant parameters related to processes for production of chemicals or products used in extraction and cultivation of raw material;
e) providing the processing unit, using the data transmission means, with said relevant parameters, said processing unit having instructions for calculating the GHG emissions by means of the GHG emissions modeling module to which is connected;
f) processing in the processing unit the relevant parameters related to each process involved in the raw material production for calculating a partial GHG emissions value related to each process, and
g) adding up said partial values for calculating an overall GHG emissions level, and
h) purchasing a raw material produced in a raw material production site wherein the overall GHG emission level related to the production of said raw material in said raw material production site is lower than a determined threshold value.

24. The method of any of claim 13 or 23, wherein the raw material is selected from at least one from the group consisting of: cereals, sugar cane, straw, forestry residues, forestry material, energy crops, organic waste, wine alcohol, aquaculture and fishery residues and oleaginous crops.

25. The method of any one of claim 13 or 23, wherein the bioproduct comprises a bioplastic.

26. The method of any one of claim 13 or 23, wherein the bioproduct comprises a form of bioenergy.

27. The method of claim 26, wherein the form of bioenergy is biofuel.

28. The method of claim 26, wherein the form of bioenergy is biogas.

29. A computer readable storage medium storing processor executable instructions for performing a method for determining greenhouse gas (GHG) emissions in the production of raw material for obtaining bioproducts, the production of raw material comprising: processes for cultivation or extraction of raw material; processes for collection of raw material; processes for treatment of raw material waste and leakages; and processes for production of chemicals or products used in extraction and cultivation of raw material, the method comprising the steps of:
a) retrieving, from a database by means of the GHG emissions modeling module, using instructions received from the processing unit, relevant parameters related to processes for extraction and cultivation or raw material;
b) retrieving, from a database by means of the GHG emissions modeling module, using instructions received from the processing unit, relevant parameters related to processes for collection of raw material;
c) retrieving, from a database by means of the GHG emissions modeling module, using instructions received from the processing unit, relevant parameters related to processes for treatment of raw material waste and leakages;
d) retrieving, from a database by means of the GHG emissions modeling module, using instructions received from the processing unit, relevant parameters related to processes for production of chemicals or products used in extraction and cultivation of raw material;
e) providing the processing unit, using the data transmission means, with said relevant parameters, said processing unit having instructions for calculating the GHG emissions by means of the GHG emissions modeling module to which is connected;
f) processing in the processing unit the relevant parameters related to each process involved in the raw material production for calculating a partial GHG emissions value related to each process, and
g) adding up said partial values for calculating an overall GHG emissions level.

30. The storage medium of claim 29, wherein the method further comprises the step of according a quality index to at least one parameter before storing said parameter in the database.

31. The storage medium of claim 30, wherein the method further comprises the steps of:
retrieving, from a database by means of the GHG emissions modeling module, using instructions received from the processing unit, the quality index of a parameter stored in the database;
comparing the quality index of a parameter stored in the database with the quality index of a parameter more recently calculated for determining whether the quality index of the parameter stored is lower than the quality index of the more recently calculated parameter;
substituting the stored parameter by the more recently calculated parameter if the comparison determines that the quality index of the parameter stored is lower than the quality index of the more recently calculated parameter.

32. The storage medium of claim 31, wherein the method further comprises the steps of:
retrieving, from a database by means of the GHG emissions modeling module, using instructions received from the processing unit, a maximum GHG emissions threshold for a determined raw material;
calculating the overall GHG emission values for said determined raw material relating a plurality of production sites for said raw material;
comparing said overall GHG emission values to said GHG emissions threshold; and
determining that a raw material production site is sustainable for the determined raw material if the GHG emissions of said raw material relating to said raw material production site are lower than the threshold.

33. The storage medium of claim 31, wherein the method further comprises the steps of:
retrieving, from a database by means of the GHG emissions modeling module, using instructions received from the processing unit, a maximum GHG emissions threshold for a determined raw material production site;
calculating the overall GHG emission values for said determined raw material production site relating a plurality of raw material for said production site;
comparing said overall GHG emission values to said GHG emissions threshold; and
determining that a raw material is sustainable for the determined raw material production site if the GHG emissions of said raw material production site relating to said raw material are lower than the threshold.

34. The storage medium of claim 29, wherein the method further comprises the step of outputting the result of the GHG emissions determined.

35. The storage medium of claim 29, wherein the method further comprises the step of outputting whether the raw material is sustainable.

36. The storage medium of claim 30, wherein the method further comprises the step of outputting whether the origin is sustainable.

37. The storage medium of claim 29, wherein the outputting is achieved through a table.

38. The storage medium of any one of claim 35 or 36 wherein the outputting is achieved through a map.

39. The storage medium of claim 29, wherein the raw material is selected from at least one from the group consisting of: cereals, sugar cane, straw, forestry residues, forestry material, energy crops, organic waste, wine alcohol, aquaculture and fishery residues and oleaginous crops.

40. The storage medium of claim 29, wherein the bioproducts comprise a bioplastic.

41. The storage medium of claim 29, wherein the bioproducts comprise a form of bioenergy.

42. The storage medium of claim 29, wherein the form of bioenergy is biofuel.

43. The storage medium of claim 29, wherein the form of bioenergy is biogas.

44. A computer readable storage medium storing processor executable instructions for performing a method for determining greenhouse gas (GHG) emissions in the production of raw material for obtaining bioproducts, the production of raw material comprising: processes for cultivation or extraction of raw material; processes for collection of raw material; processes for treatment of raw material waste and leakages; and processes for production of chemicals or products used in extraction and cultivation of raw material, wherein the method comprises the steps of:
a) retrieving, from a database by means of the GHG emissions modeling module, using instructions received from the processing unit, relevant parameters related to processes for extraction and cultivation or raw material;
b) retrieving, from a database by means of the GHG emissions modeling module, using instructions received from the processing unit, relevant parameters related to processes for collection of raw material;
c) retrieving, from a database by means of the GHG emissions modeling module, using instructions received from the processing unit, relevant parameters related to processes for treatment of raw material waste and leakages;
d) retrieving, from a database by means of the GHG emissions modeling module, using instructions received from the processing unit, relevant parameters related to processes for production of chemicals or products used in extraction and cultivation of raw material;
e) providing the processing unit, using the data transmission means, with said relevant parameters, said processing unit having instructions for calculating the GHG emissions by means of the GHG emissions modeling module to which is connected;
f) processing in the processing unit the relevant parameters related to each process involved in the raw material production for calculating a partial GHG emissions value related to each process, and
g) adding up said partial values for calculating an overall GHG emissions level, and
h) purchasing a raw material produced in a raw material production site wherein the overall GHG emission level related to the production of said raw material in said raw material production site is lower than a determined threshold value.
